(19) United States
(12) Patent Application Publication
(10) Pub. No.: US 2026/0214481 A1
(43) Pub. Date: Jul. 23, 2026

(54) METHOD FOR WIRELESS COMMUNICATION, AND TERMINAL DEVICE AND NETWORK DEVICE THEREFOR

(71) Applicant: Quectel Wireless Solutions Co., Ltd., Shanghai (CN)

(72) Inventor: Zheng ZHAO, Shanghai (CN)

(73) Assignee: Quectel Wireless Solutions Co., Ltd., Shanghai (CN)

(21) Appl. No.: 19/577,687

(22) Filed: Mar. 25, 2026

Related U.S. Application Data
(63) Continuation of application No. PCT/CN2023/127844, filed on Oct. 30, 2023.

(51) Int. Cl. H04W 24/08

(52) U.S. Cl. CPC H04W 24/08

(57) ABSTRACT

A method for wireless communication includes: receiving, by a terminal device, first configuration information from a network device. The first configuration information is used to configure a first time window, and the terminal device is to transmit a first signal within the first time window, the first signal is used to determine an RTT between the terminal device and the network device, and the RTT is implemented based on a second signal received by the terminal device.

### CROSS-REFERENCE TO RELATED APPLICATIONS

This application is a continuation of International Application No. PCT/CN2023/127844, filed on Oct. 30, 2023, the disclosure of which is hereby incorporated by reference in its entirety.

### TECHNICAL FIELD

The present disclosure relates to the technical field of communications, and in particular, relates to a method for wireless communication, and a terminal device and a network device therefor.

### BACKGROUND

In a communication system, a round trip time (RTT) is determined based on uplink (UL) and downlink (DL) signals transmitted between a network device and a terminal device. The RTT may be used to position the terminal device. Between a reception time of a downlink signal and a transmission time of an uplink signal, movement of the terminal device or the network device may lead to a problem of positioning inaccuracy. For example, in non-terrestrial network (NTN) systems, satellite movement may introduce timing drift (also referred to as RTT drift). In a case where an interval between the reception time of the downlink signal and the transmission time of the uplink signal is excessively long, significant accumulation of timing drift may occur, which in turn leads to a degradation of positioning accuracy.

### SUMMARY

Embodiments of the present disclosure provide a method for wireless communication, and a terminal device and a network device therefor. Various aspects of the embodiments of the present disclosure are described hereinafter.

In a first aspect of the embodiments of the present disclosure, a method for wireless communication is provided. The method includes: receiving, by a terminal device, first configuration information from a network device; wherein the first configuration information is used to configure a first time window, and the terminal device is to transmit a first signal within the first time window, wherein the first signal is used to determine an RTT between the terminal device and the network device, the RTT being implemented based on a second signal received by the terminal device.

In a second aspect of the embodiments of the present disclosure, a method for wireless communication is provided. The method includes: transmitting, by a network device, first configuration information to a terminal device; wherein the first configuration information is used to configure a first time window, and the terminal device is to transmit a first signal within the first time window, wherein the first signal is used to determine an RTT between the terminal device and the network device, the RTT being implemented based on a second signal received by the terminal device.

In a third aspect of the embodiments of the present disclosure, a terminal device is provided. The terminal device includes: a receiving unit, receiving first configuration information from a network device; wherein the first configuration information is used to configure a first time window, and the terminal device is to transmit a first signal within the first time window, wherein the first signal is used to determine an RTT between the terminal device and the network device, the RTT being implemented based on a second signal received by the terminal device.

In a fourth aspect of the embodiments of the present disclosure, a network device is provided. The network device includes: a transmitting unit, transmitting first configuration information to a terminal device; wherein the first configuration information is used to configure a first time window, and the terminal device is to transmit a first signal within the first time window, wherein the first signal is used to determine an RTT between the terminal device and the network device, the RTT being implemented based on a second signal received by the terminal device.

In a fifth aspect of the embodiments of the present disclosure, a terminal device is provided. The terminal device includes a processor and a memory; wherein the memory is configured to store one or more computer programs, and the processor is configured to call the one or more computer programs stored in the memory to cause the terminal device to perform part or all of the steps in the method according to the first aspect.

In a sixth aspect of the embodiments of the present disclosure, a network device is provided. The network device includes a processor, a memory, and a transceiver; wherein the memory is configured to store one or more computer programs, and the processor is configured to call the one or more computer programs stored in the memory to cause the network device to perform part or all of the steps in the method according to the second aspect.

In a seventh aspect of the embodiments of the present disclosure, a communication system is provided. The communication system includes the terminal device and/or the network device as described above. In some embodiments, the communication system may include other devices capable of interacting with the terminal device or the network device in the technical solutions according to the embodiments of the present disclosure.

In an eighth aspect, a computer-readable storage medium is provided. The computer-readable storage medium stores one or more computer programs therein. The one or more computer programs, when loaded and run by a terminal device and/or a network device, cause the terminal device and/or the network device to perform part or all the steps in the methods according to the above aspects.

In a ninth aspect, a computer program product is provided. The computer program product includes a non-transitory computer-readable storage medium storing one or more programs therein. The one or more computer programs, when loaded and run by a terminal device and/or a network device, cause the terminal device and/or the network device to perform part or all the steps in the methods according to the above aspects. In some embodiments, the computer program product may be a software package.

In a tenth aspect, a chip is provided. The chip includes a memory and a processor. The processor is configured to call and run a computer program from the memory to perform part or all the steps in the methods according to the above aspects.

### BRIEF DESCRIPTION OF THE DRAWINGS

FIG. 1 is a schematic diagram of a wireless communication system according to some embodiments of the present disclosure.

FIG. 2 illustrates an example of a method for determining an RTT.

FIG. 3A illustrates an example of a multi-RTT positioning scenario.

FIG. 3B illustrates an example of a multi-RTT positioning scenario under an NTN.

FIG. 3C illustrates an example of a multi-RTT positioning scenario under an NTN.

FIG. 4 is a schematic flowchart of a method for wireless communication according to some embodiments of the present disclosure.

FIG. 5 is a schematic flowchart of a method for wireless communication according to Embodiment 1 of the present disclosure.

FIG. 6 is a schematic flowchart of a method for wireless communication according to Embodiment 2 of the present disclosure.

FIG. 7 is a schematic flowchart of a method for wireless communication according to Embodiment 3 of the present disclosure.

FIG. 8 is a schematic flowchart of a method for wireless communication according to Embodiment 4 of the present disclosure.

FIG. 9 is a schematic structural diagram of a terminal device according to some embodiments of the present disclosure.

FIG. 10 is a schematic structural diagram of a network device according to some embodiments of the present disclosure.

FIG. 11 is a schematic structural diagram of an apparatus for communication according to some embodiments of the present disclosure.

### DETAILED DESCRIPTION OF THE EMBODIMENTS

The technical solutions of the present disclosure are described in detail with reference to the accompanying drawings.

### Communication System

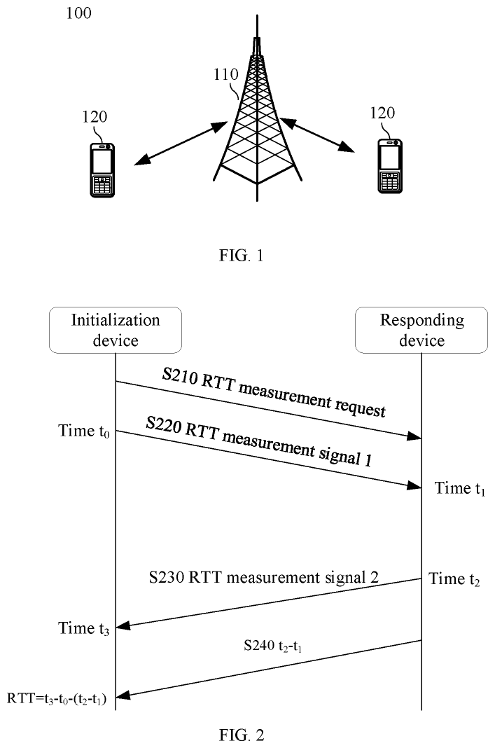

FIG. 1 illustrates a wireless communication system according to some embodiments of the present disclosure. The wireless communication system 100 includes a communication device. The communication device may include a network device 110 and a terminal device 120. The network device 110 may be a device in communication with the terminal device 120.

FIG. 1 exemplarily illustrates one network device and two terminal devices. Optionally, the wireless communication system 100 may include a plurality of network devices and each of the network devices provide a coverage area for terminal devices in other quantities, which is not limited in the embodiments of the present disclosure.

Optionally, the wireless communication system 100 may further include another network entity such as a network controller, a mobility management entity, or the like, which is not limited in the embodiments of the present disclosure.

It should be understood that the technical solutions according to the embodiments of the present disclosure may be applied to various communication systems, for example: a 5^{th} generation (5G) or a new radio (NR) system, a long-term evolution (LTE) system, an LTE frequency-division duplex (FDD) system, an LTE time-division duplex (TDD) system, or the like. The technical solutions according to the present disclosure may also be applied to future communication systems, such as a 6^{th} generation (6G) mobile communication system, such as a satellite communication system or the like.

The terminal device according to the embodiments of the present disclosure may also be referred to as a user equipment (UE), an access terminal, a subscriber unit, a subscriber station, a mobile station (MS), a mobile terminal (MT), a remote station, a remote terminal, a mobile device, a user terminal, a wireless communication device, a user agent, or a user apparatus. The terminal device according to the embodiments of the present disclosure may refer to a device providing voice and data connectivity for users, or device capable of connecting to human, things, and machines, for example, a handheld device, a vehicle-mounted device or the like having a wireless connection function. The terminal device according to the embodiments of the present disclosure may be a mobile phone, a pad, a laptop, a palmtop, a mobile Internet device (MID), a wearable device, a virtual reality (VR) device, an augmented reality (AR) device, a wireless terminal in industrial control, a wireless terminal in self-driving, a wireless terminal in remote medical surgery, a wireless terminal in smart grid, a wireless terminal in transportation safety, a wireless terminal in smart city, a wireless terminal in smart home, or the like. Optionally, the UE may serve as a base station. For example, the UE may serve as a dispatch entity, which provides sidelink signals between terminal devices in vehicle-to-everything (V2X) or device-to-device (D2D) communications or the like. For example, a cellular phone and a vehicle communicate with each other based on the sidelink signals. The cellular phone and a smart home device communicate with each other, with no need of relaying communication signals over a base station.

The network device according to the embodiments of the present disclosure may be a device for communicating with the terminal device. The network device may also include an access network device. The access network device may provide communication coverage for a specific geographical region, and may communicate with any terminal device 120 within the coverage area. The access network device may also be referred to as a radio access network device, a base station, or the like. The network device according to the embodiments of the present disclosures may refer to a radio access network (RAN) node (or device) that accesses (connects) a terminal device to a wireless network. The access network device may broadly cover or replace various names such as, a node B (NodeB), an evolved base station (evolved NodeB, eNB), a next generation base station (next generation NodeB, gNB), a relay station, a transmission and reception point (TRP), a transmission point (TP), an access point (AP), a primary station MeNB, and a secondary station SeNB, a multi-standard radio (MSR) node, a home base station, a network controller, an access node, a wireless node, a transmission node, a transceiver node, a baseband unit (BBU), a remote ratio unit (RRU), an active antenna unit (AAU), a remote radio head (RRH), and a central unit (CU), a distributed unit (DU), a positioning node, and the like. The base station may be a macro base station, a micro base station, a relay node, a donor node, or the like, or a combination thereof. The base station may also refer to a communication module, a modem, or a chip configured in the above apparatus or device. The base station may also be a mobile switching center and a device in D2D, V2X, or machine-to-machine (M2M) communication to assume the function of a base station, a network-side device in a 6G network, a device in a future communication system to assume the function of a base station, or the like. The base station may support networks of the same or different access technologies. The embodiments of the present disclosure do not limit the specific technology and the specific device form adopted by the access network device.

The base station may be stationary or mobile. For example, a helicopter or unmanned aerial vehicle may be configured to serve as a mobile base station, and one or more cells may move depending on the location of the mobile base station. In other examples, the helicopter or unmanned aerial vehicle may be configured to serve as a device to communicate with another base station.

Communication devices involved in a wireless communication system may include not only access network devices and terminal devices, but also core network elements. A core network element may be implemented as a device. That is, the core network element is a core network device. It may be understood that the core network device may also be a type of network device.

In the embodiments of the present disclosure, a core network element may include an element for processing and forwarding user signaling and data. For example, the core network devices may include a core access and mobility management function (AMF), a session management function (SMF), a user plane gateway, a location management function (LMF), and the like. The user plane gateway may be a server configured to perform functions such as mobility management, routing, and forwarding of user plane data. This server is generally located on the network side and may be, for example, a serving gateway (SGW), a packet data network gateway (PGW), or a user plane function (UPF). Nevertheless, the core network may include other network elements, which are not enumerated herein.

In some deployments, the network device according to the embodiments of the present disclosure may refer to a CU or a DU, or the network device includes a CU and a DU. The gNB may also include an AAU.

The network device and the terminal devices may be deployed on land, including indoor or outdoor, hand-held, or vehicle-mounted; or may be deployed on the water surface; or may be deployed on airplanes, balloons, and satellites. In the embodiments of the present disclosure, the scenario wherein the network device and the terminal devices are located is not limited.

It will be understood that all or part of the functionality of the communication devices in the present disclosure may also be implemented by software functions running on hardware, or by virtualization functions instantiated on a platform, such as a cloud platform.

### NTN

The NTN may provide communication services to users via non-terrestrial means. That is, communication with a terminal device may be performed via a non-terrestrial network device such as a satellite (SAT), an unmanned aircraft system (UAS) platform, or the like.

For terrestrial network communication, in scenarios such as oceans, high mountains, and deserts, the deployment of communication equipment is not feasible. Alternatively, considering the cost of deploying and operating communication devices, terrestrial communication typically does not cover sparsely populated areas. Compared with terrestrial network communication, NTN has many merits. First, an NTN communication network is not geographically restricted. Theoretically, a satellite is capable of moving in orbit around the Earth; therefore, every corner of the Earth may be covered by satellite communication. Furthermore, the coverage area of an NTN network device is much larger than that of a terrestrial communication device. That is, an NTN cell is capable of covering a larger area.

An NTN network device may move relative to the Earth, and therefore, in the NTN, a cell may move across the surface of the Earth. This phenomenon may make it difficult for a network device to reliably determine the position of a terminal device, or even to determine the country where the terminal device is located, which may in turn make it difficult for the NTN to support regulatory services. For this reason, relying solely on global navigation satellite system (GNSS) reports from the terminal device is unreliable, and a solution that combines GNSS reports with network-based solutions improves reliability. Therefore, in addition to the GNSS-based position reported by the terminal, a network operator should cross-check the position of the terminal device in order to meet potential regulatory requirements.

### Positioning Technology

As communication technologies advance, some communication systems (e.g., 5G systems) may implement an increasing number of communication algorithms. These communication algorithms may include high-speed information transmission, positioning technologies, and the like. For example, for the NTN system, positioning of a terminal device may be achieved not only via GNSS but also via communication algorithms, so as to meet the requirements of the NTN system.

Some wireless communication systems may include a server. The calculation of the position coordinates of the terminal device may be performed in the server. Such a server may also be referred to as a positioning server.

The positioning server may be a network device with positioning functionality provided by an operator. The network device with positioning functionality may be a core network device or a cloud server. For example, the positioning server involved in the embodiments of the present disclosure may include one or more of a location management function (LMF), a location management component (LMC), and local location management function (LLMF) located in a network device, which is not limited in the embodiments of the present disclosure.

Among positioning technologies, the RTT-based positioning technology is given priority due to its advantages of high accuracy and independence from timing synchronization between the network device and the terminal device. The RTT-based positioning technology is described hereinafter.

### RTT-Based Positioning

In a communication system, RTT positioning is determined based on UL signals and DL signals transmitted between a network device and a terminal device. The transmitted signals may be, for example, reference signals. FIG. 2 illustrates an example of a method for determining an RTT.

The method illustrated in FIG. 2 may be performed by an initialization device and a responding device. The responding device may be a device to be positioned. For example, the responding device may be a terminal device, and the initialization device may be a network device. The network device may be, for example, an access network device.

The method illustrated in FIG. 2 may include step S210 to step S240.

In step S210, the initialization device transmits an RTT measurement request to the responding device.

In step S220, the initialization device transmits an RTT measurement signal 1 to the responding device.

The initialization device transmits the RTT measurement signal 1 at time t₀. Due to transmission delay, the responding device receives the RTT measurement signal 1 at time t₁. That is, a time of arrival (TOA) of the RTT measurement signal 1 is time t₁.

The RTT measurement signal 1 may include, for example, a DL positioning reference signal (PRS).

In step S230, the responding device transmits an RTT measurement signal 2 to the initialization device.

The responding device transmits the RTT measurement signal 2 at time t₂. Due to transmission delay, the initialization device receives the RTT measurement signal 2 at time t₃. That is, a TOA of the RTT measurement signal 2 is time t₃.

The RTT measurement signal 2 may include, for example, a sounding reference signal (SRS).

In a case where the initialization device is a network device, a difference (t₃−t₀) between time t₃ and time t₀ may be expressed as a gNB reception and transmission time difference, denoted as gNB_{Rx-Tx}.

In some embodiments, gNB_{Rx-Tx} may satisfy: gNB_{Rx-Tx}=T_{gNB-RX}−T_{gNB-TX}. T_{gNB-RX} may be a reception timing at a transmission reference point (TRP) (or simply referred to as a reference point) of uplink subframe #i containing an SRS associated with the terminal device, defined by a first detected time path. T_{gNB-TX} may be a transmission timing at a TRP of downlink subframe #j that is closest in time t₀ subframe #i received from the terminal device. A plurality of SRS resources may be used to determine start of a subframe containing the SRS.

In step S240, the responding device transmits a difference (t₂−t₁) between time t₂ and time t₁ to the initialization device via an RTT report. In a case where the responding device is a terminal device, the difference between time t₂ and time t₁ may be expressed as a reception and transmission time difference of the terminal device, denoted as UE_{Rx-Tx}.

In some embodiments, UE_{Rx-Tx} may satisfy: UE_{Rx-Tx}=T_{UE-RX}−T_{UE-TX}. T_{UE-RX} represents a timing at the terminal device of downlink subframe #i received from a transmission point (TP), defined by the first detected time path. T_{UE-TX} represents a transmission timing at the terminal device of uplink subframe #j that is closest in time to subframe #i received from the TP. A plurality of DL PRSs or CSI-RSs may be used to determine this subframe.

Based on time t₀, time t₃, and the received difference between time t₂ and time t₁, the RTT may be calculated. For example, the RTT may satisfy: RTT=t₃−t₀−(t₂−t₁).

Exemplarily, the terminal device may transmit an RTT report to a positioning server, wherein the RTT report may include UE_{Rx-Tx} measured for at least one network device. The network device may transmit an RTT report to the positioning server, wherein the RTT report may include gNB_{Rx-Tx}. The positioning server may determine the RTT according to RTT=gNB_{Rx-Tx}−UE_{Rx-Tx}. The RTT report may also be referred to as a measurement report.

For the communication system, prior to step S210, the positioning server may transmit PRS configuration information to the terminal device to indicate DL PRS configurations associated with different network devices to the terminal device. The positioning server may also indicate UL PRS (e.g., SRS) information to the terminal device, such that the terminal device transmits a UL PRS based on the UL PRS information for the network device to perform measurements.

RTT-based positioning typically requires using a plurality of RTTs to achieve positioning. For example, in a communication system, a plurality of RTTs between network devices (e.g., gNBs) and the terminal device may be measured. Based on the plurality of RTTs, distances between the terminal device and each network device may be determined, such that the position of the terminal device is calculated.

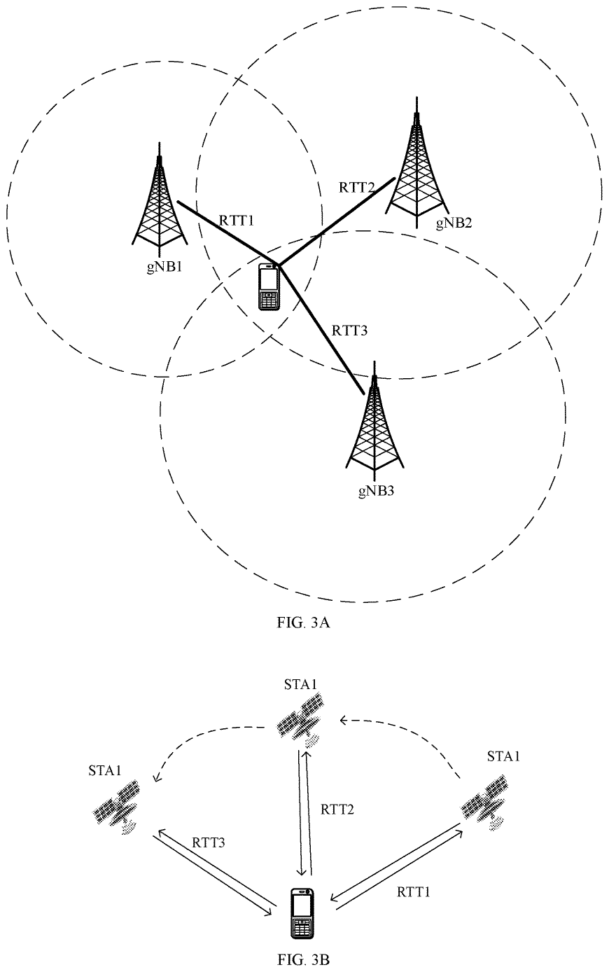

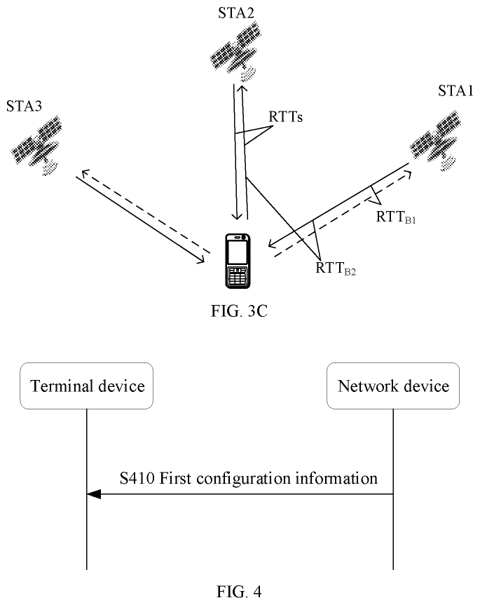

As illustrated in FIG. 3A positioning of the terminal device may be achieved using three network devices. In FIG. 3A, the three network devices are gNB1, gNB2, and gNB3 respectively. The position of the terminal device may be calculated based on RTT1 between gNB1 and the terminal device, RTT2 between gNB2 and the terminal device, and RTT3 between gNB3 and the terminal device.

It should be noted that FIG. 3A is only an example, and positioning of the terminal device may be achieved using a different number of network devices.

### RTT Positioning in NTN

In the NTN, the multi-RTT technology may be categorized into the following two types: single-satellite multi-RTT and multi-satellite multi-RTT.

Single-satellite multi-RTT may leverage the movement of a low Earth orbit (LEO) satellite to perform multiple measurements at different times, such that distances between a plurality of reference points of the satellite and a terminal device are acquired.

FIG. 3B is a schematic diagram of an example scenario for single-satellite multi-RTT. As illustrated in FIG. 3B, STA1 moves along an orbit indicated by dashed lines. During the movement of STA1, RTTs between STA1 at different reference points and the terminal device may be measured to acquire RTT1, RTT2, and RTT3. By combining these three RTTs, the distances from these three reference points to the terminal device may be calculated, such that position of the terminal device is calculated.

Multi-satellite multi-RTT involves performing measurements based on a plurality of satellites at approximately the same time to acquire distances between the plurality of satellites and the terminal device.

FIG. 3C is a schematic diagram of an example scenario for multi-satellite multi-RTT. As illustrated in FIG. 3C, within a close time proximity, three satellites (STA1, STA2, and STA3) all transmit downlink signals to the terminal device. STA2 is a serving satellite, and STA1 and STA3 are both non-serving satellites. The terminal device may transmit an uplink signal to STA2. Based on this uplink signal and a downlink signal transmitted by STA2, the RTTs between the serving satellite and the terminal device may be determined.

In FIG. 3C, the terminal device may transmit an uplink signal to STA1 (indicated by dashed lines), thereby determining RTT_{B1} between STA1 and the terminal device. An RTT between STA1 and the terminal device may also be calculated based on the uplink signal transmitted by the terminal device to STA2, thereby acquiring RTT_{B2}. It may be understood that calculating RTT_{B2} may reduce the number of uplink signals transmitted by the terminal device, such that communication resources are saved.

In some standards for terrestrial communication, UE_{Rx-Tx} only supports time difference reporting within a small range. This small range may be, for example, [−0.5 ms, 0.5 ms]. However, in NTN, due to a long distance between the satellite and the terminal device, a round trip delay far exceeds this range. Therefore, the technical solution needs to be modified or enhanced. Correspondingly, gNB_{Rx-Tx} may also need to be modified or enhanced.

To address the problem, one possible solution, denoted as Option 1 (alt 1), is to maintain the definition of UE_{Rx-Tx} from the related art and have the terminal device additionally report an NTN-specific integer offset. The problem with Option 1 is that, due to the influence of timing drift during satellite movement and timing advance adjustments of the terminal, the positioning accuracy may not satisfy a 10-km requirement. Another possible solution, denoted as Option 2 (alt 2) and Option 3 (alt 3), is to support the terminal device in reporting the time difference (i.e., the absolute time difference) between the time of arrival of the PRS for positioning and the transmission time of the SRS. It may be understood that this solution is not affected by timing drift, but significant modifications to the related art may be required. For implementation of this solution, in addition to modifying the definition of UE_{Rx-Tx}, it is necessary to additionally indicate a coupling relationship between the PRS and the SRS, such that the terminal device and the network device have a common understanding of which pair of PRS and SRS to measure for RTT calculation.

As the technology evolves, Option 1 is continuously being revised.

The content of the modified Option 1 includes: a UE_{Rx-Tx} time difference based on Option 3 (without precluding Option 1) and a gNB_{Rx-Tx} time difference as defined in TS 38.215.

The content of the modified Option 1 includes: Option 1: The UE_{Rx-Tx} time difference is defined based on Rx and Tx subframe timings associated with the TRP. T_{UE-Rx} is a timing of downlink subframe #i received by the UE from the TP, defined by the first detected time path. T_{UE-Tx} is a transmission timing at the terminal device of an uplink subframe corresponding to subframe #i received from the TP. Based on an indication from a higher layer, one or more DL RSs for positioning may be used to determine start of a subframe for the first arrival path from the TP.

Option 3: NTN adopts the UE_{Rx-Tx} time difference defined in the related art (e.g., R17) and determines an offset according to one of the following options: Option 3-1: The offset is reported as a nearest integer value in milliseconds by rounding a time difference between a transmission timing of uplink subframe #i and a reception timing of downlink subframe #i. Option 3-2: The terminal device reports an index of subframe j that is closest in time to subframe #i received from the TP, and the positioning server may derive the offset from the index. Option 3-3: A TA value, which corresponds to the time difference between the reception time of downlink subframe #i and the transmission time of uplink subframe #i, is rounded to slot-level granularity and reported.

Additionally, in the related art, the terminal device should transmit an SRS within 160 ms upon receiving a PRS.

In RTT positioning, between a reception time of a downlink signal and a transmission time of an uplink signal, movement of the terminal device or the network device may lead to a problem of positioning inaccuracy. For example, in NTN systems, satellite movement can introduce timing drift. In a case where an interval between the reception time of the downlink signal and the transmission time of the uplink signal is excessively long, significant accumulation of timing drift may occur, which in turn leads to a degradation of positioning accuracy.

To address this issue, possible solutions may include, for example: reducing the time difference between the reception time of the downlink signal and the transmission time of the uplink signal to reduce timing drift; or having the terminal estimate the timing drift, wherein the terminal device either compensates for the timing drift in a reported UE_{Rx-Tx} RTT report, or directly reports the timing drift for this period to the positioning server.

In response to this problem, the present disclosure provides a solution illustrated in FIG. 4. FIG. 4 is a schematic flowchart of a method for wireless communication according to some embodiments of the present disclosure. The method illustrated in FIG. 4 may be performed by a terminal device and a network device. Herein, the network device may include one or more of: a positioning server, an access network device, or an NTN device.

The method illustrated in FIG. 4 may include step S410.

In step S410, the terminal device receives first configuration information from the network device.

The first configuration information is used to configure a first time window. The terminal device needs to transmit a first signal within the first time window. That is, the network device may schedule the terminal device to transmit the first signal within the first time window.

The first signal may be used to determine an RTT between the terminal device and the network device. Additionally, the RTT is also implemented based on a second signal received by the terminal device.

The transmitter of the first signal or the receiver of the second signal may include a non-terrestrial communication device. That is, the first signal and the second signal may be used to implement RTT-based positioning under an NTN.

Exemplarily, both the first signal and the second signal may be signals used for positioning. For example, the first signal may include an SRS. The second signal may include a PRS. In a case where the first signal includes an SRS, the first time window may also be referred to as an SRS time window.

Based on the first configuration information, the network device may configure a transmission time interval for the first signal, such that the problems caused by a time difference between a transmission time of the first signal and a reception time of the second signal is avoided.

The time at which the terminal device receives the second signal may be a first time. A start time of the first time window may be earlier than, later than, or equal to the first time. An end time of the first time window may be earlier than, later than, or equal to the first time. Accordingly, it may be understood that the terminal device may transmit the first signal prior to receiving the second signal, at the time of receiving the second signal, or subsequent to receiving the second signal.

The first time window may be accurate to slot-level precision. That is, the first time window may be represented at a slot granularity.

The present disclosure does not limit the manner in which the first configuration information indicates the first time window. For example, the first configuration information may be used to indicate one or more of: the start time of the first time window, the end time of the first time window, or a duration of the first time window.

Exemplarily, the first configuration information may indicate the start time of the first time window and the end time of the first time window. Alternatively, the first configuration information may indicate the start time of the first time window and the duration of the first time window. Alternatively, the first configuration information may indicate only the start time of the first time window.

In some embodiments, the start time of the first time window may be indicated by a first offset. That is, in the case of indicating the start time of the first time window, the first configuration information may indicate the first offset. The start time of the first time window may be a sum of the first offset and the first time. That is, the first time window may be a time window that starts with an offset of the first offset relative to the reception time of the second signal.

It should be noted that the first offset may be a positive value, a negative value, or 0. That is, the first time window may start prior to the first time, subsequent to the first time, or at the first time.

In some embodiments, the end time of the first time window may be indicated by a second offset. That is, in the case of indicating the end time of the first time window, the first configuration information may indicate the second offset. The end time of the first time window may be a sum of the second offset and the first time.

It should be noted that the second offset may be a positive value, a negative value, or 0. That is, the first time window may end prior to the first time, subsequent to the first time, or at the first time.

In some embodiments, the first time window may be determined based on the demand for positioning accuracy and/or a timing drift situation. Exemplarily, the duration of the first time window may be defined such that the positioning accuracy satisfies requirements.

In some embodiments, the duration of the first time window may be pre-configured and/or pre-set. Exemplarily, the first configuration information may not need to indicate the end time or the duration of the first time window. The end time of the first time window may be determined based on the start time of the first time window indicated by the first configuration information and the pre-configured and/or pre-defined duration of the first time window. In this case, the duration of the first time window may achieve an RTT calculation that satisfies the requirements under any timing drift rate.

In some embodiments, the first signal may be a first-type signal. The first-type signal may be, for example, an SRS. The terminal device may transmit one or more SRSs, wherein the one or more SRSs may include the first signal.

In some embodiments, the second signal may be a second-type signal, wherein the second-type signal may be, for example, a PRS. The network device may transmit one or more PRSs to the terminal device, wherein the one or more PRSs may include the second signal.

Optionally, the first time window may be determined based on scheduling information of the first-type signal. The scheduling information may be information for periodic scheduling or for activated semi-persistent scheduling.

Exemplarily, the first time window may include transmission times of one or more first-type signals scheduled based on the scheduling information.

As a possible implementation, in a case where a duration between a transmission time of the first-type signal scheduled based on the scheduling information and the first time is less than a first threshold, the first time window may include a transmission time of the first-type signal. The first threshold may be, for example, 160 ms.

For example, the terminal device may have received a periodic or activated semi-persistent SRS configuration. In this case, where an SRS is to be transmitted within 160 ms of reception of the PRS, the first time window may be configured to include at least one SRS. Alternatively, the terminal device may not be scheduled for periodic SRS transmission or may not have an activated semi-persistent SRS configuration. In this case, the network device may configure any suitable first time window, and schedule the terminal device to transmit at least one SRS within the first time window.

As described above, the first time window may ensure the transmission time of the first signal. In addition, for NTN, the network device may also clarify the time interval for the first signal transmission by configuring the first time window, such that timing drift caused by satellite motion is avoided as much as possible. The solution is described in detail hereinafter.

In some embodiments, the first time window may be used to determine a timing drift-induced offset in a process of determining an RTT.

Exemplarily, the first time window may be used to estimate a first time difference between a reception time of the second signal and the transmission time of the first signal. That is, by configuring the first time window, the network device may estimate the first time difference. The first time difference may be used to determine the timing drift-induced offset.

Optionally, the first time difference may be determined based on a center time of the first time window and an expected time of arrival of the second signal.

In some implementations, the timing drift-induced offset may satisfy:

$$offset = rate \times ( delta + \frac{{UE}_{Rx - Tx}}{a} ) .$$

Herein, rate represents the timing drift rate, delta represents the first time difference, UE_{Rx-Tx} represents the time difference between the terminal device receiving the second signal and sending the first signal, and a is a positive number. For example, a may be 2.

It may be understood that

$$( delta + \frac{{UE}_{Rx - Tx}}{a} )$$

may be a time period for which timing drift needs to be eliminated. The timing drift-induced offset may be acquired by multiplying this time period by the timing drift rate.

It should be noted that the value of UE_{Rx-Tx} may be the time difference indicated in a time difference report reported by the terminal device.

It should be noted that UE_{Rx-Tx} may be the time difference described in Option 1, or the time difference in Option 2 or Option 3. For example, UE_{Rx-Tx} may satisfy: UE_{Rx-Tx}=T_{UE-RX}−T_{UE-TX}. Herein, T_{UE-RX} represents a timing of downlink subframe #i received by the terminal device from a TP, defined by the first detected time path. T_{UE-TX} represents a transmission timing at the terminal device of uplink subframe #j that is closest in time to subframe #i received from the TP. Still for example, UE_{Rx-Tx} may be an absolute time difference between the time of arrival of the second signal and the transmission time of the first signal.

The timing drift rate may be determined, for example, based on satellite ephemeris information and a reference point within a cell corresponding to the satellite. The reference point may be located at any position within the cell. For example, the reference point may be a GNSS position of the terminal device or a center position of the cell. Considering that the timing drift rates within the cell corresponding to the satellite differ slightly, the setting of the reference point does not need to be overly precise.

Exemplarily, the timing drift rate may be determined based on an elevation angle between the terminal device and the satellite. For example, the larger the degree of the elevation angle, the smaller the timing drift rate and the smaller the timing drift-induced offset. When the elevation angle is 90 degrees, a timing drift-induced offset of a LEO satellite with an earth orbit of 1200 km may be 0 us/s. When the elevation angle is 0 degrees, the timing drift-induced offset of the LEO satellite with an earth orbit of 1200 km may be 83 us/s.

Based on the timing drift-induced offset, the RTT may be determined. For example, the RTT may satisfy: RTT=UE_{Rx-Tx}+gNB_{Rx-Tx}+offset. UE_{Rx-Tx} represents a time difference between receiving the second signal and transmitting the first signal at the terminal device, and gNB_{Rx-Tx} represents a time difference between receiving the first signal and transmitting the second signal at the network device. UE_{Rx-Tx} may be determined based on a report from the terminal device. gNB_{Rx-Tx} may be determined based on a report from the satellite. That is, the positioning server may acquire a more accurate RTT based on a calculated timing drift-induced offset, an RTT report from the terminal device, and an RTT report from the network device. This RTT may correct for the impact of the timing drift-induced offset on the RTT.

Based on the calculated RTT, a distance between the terminal device and the satellite may be acquired. A reference position of the satellite may be determined based on ephemeris information, and thus the position of the terminal device may be acquired. For example, based on a plurality of reference positions of a satellite and a plurality of RTTs calculated, the position of the terminal device may be acquired. Alternatively, based on a plurality of RTTs calculated by a plurality of satellites within a close time frame, the position of the terminal device may be acquired.

In some embodiments, the terminal device receives a plurality of second signals. The plurality of second signals may all be used to calculate the RTT. For example, in multi-satellite multi-RTT, a plurality of satellites may transmit a corresponding plurality of second signals. In this case, one or more first time windows may be configured. One or more first signals coupled with the plurality of second signals may be transmitted within the configured one or more first time windows.

For example, in a case where a difference in reception times of the plurality of second signals is less than or equal to a second threshold, only one first time window may be configured. That is, the first signals coupled with the plurality of second signals may all be transmitted within the first time window. In this way, the number of configured first time windows may be reduced, and hence the effects of simple implementation are achieved and communication resources are saved.

Still for example, in a case where a difference in reception times of the plurality of second signals is greater than the second threshold, a plurality of first time windows may be configured to adaptively transmit the coupled first signals based on the second signals, such that the problem of inaccurate positioning caused by an excessive time difference between the transmission time of a first signal and the reception time of a second signal is avoided.

It should be noted that the second threshold may be an integer. The second threshold may be, for example, 320 ms.

For example, in a case where the difference between the expected time of arrivals of all PRSs does not exceed 320 ms, the gNB may configure one first time window. Exemplarily, the expected time of arrival of a PRS transmitted by Sat A is around 0 ms; the expected time of arrival of a PRS transmitted by Sat B is around 150 ms; and the expected time of arrival of a PRS transmitted by Sat C is around 300 ms. Herein, Sat A is the serving satellite. It may be seen that the difference in the expected time of arrivals of the PRSs transmitted by Sat A, Sat B, and Sat C does not exceed 320 ms. Therefore, the interval of the first time window may be configured as (140 ms, 160 ms). That is, the start time of the first time window is 140 ms, and the end time is 160 ms.

Still for example, in a case where the difference in the expected time of arrivals between two or more groups of PRSs from non-serving satellites does not exceed 320 ms, but the expected time of arrival of another group of PRSs differs from the expected time of arrivals of all other PRSs by more than 320 ms, two first time windows may be configured. Exemplarily, the expected time of arrival of the PRS transmitted by Sat A is 0 ms; the expected time of arrival of the PRS transmitted by Sat B is 330 ms; and the expected time of arrival of the PRS transmitted by Sat C is 500 ms. The gNB may configure, for the terminal device, one first time window in an interval (−160 ms, 160 ms) and another first time window in an interval (340 ms, 490 ms).

Still for example, in a case where the difference in the expected time of arrivals between two or more groups of PRSs does not exceed 320 ms, and the expected time of arrival of another group of PRSs differs from one or more groups of PRSs by no more than 320 ms, but differs from the time of arrivals of other PRSs by more than 320 ms, a plurality of first time windows may be configured. Exemplarily, the expected time of arrival of the PRS transmitted by Sat A is 0 ms; the expected time of arrival of the PRS transmitted by Sat B is 300 ms; and the expected time of arrival of the PRS transmitted by Sat C is 500 ms. The gNB may configure one first time window in an interval (140 ms, 160 ms) and another first time window in an interval (340 ms, 460 ms), respectively. In this case, the gNB may select, according to its own situation, select SRS in any one of the time windows for measurement to complete the RTT measurement relative to Sat B.

In some embodiments, the first configuration information may also be used to indicate a coupling between the first signal and the second signal.

Optionally, the first configuration information may indicate a subframe in which the second signal is located. That is, the network device may select a downlink signal (e.g., PRS) that may be used for coupled measurement and indicate to the terminal the subframe in which this downlink signal is located.

That is, based on the first configuration information, the technical solution according to the present disclosure may also be applied to Option 2/Option 3 in the related art.

In some embodiments, the access network device or the positioning server may transmit configuration information for reference signals. The configuration information may include: configuration information for an uplink reference signal and/or configuration information for a downlink reference signal. The configuration information for the uplink reference signal may be used to configure the first-type signal. The configuration information for the downlink reference signal may be used to configure the second-type signal. The configuration information for the uplink reference signal may be used, for example, to configure radio resources for the uplink reference signal. The configuration information for the downlink reference signal may be used, for example, to configure radio resources for the downlink reference signal.

Exemplarily, the configuration of the downlink reference signal may include one or more: information on time resources (e.g., slots), frequency resources (e.g., frequency blocks), code resources (e.g., code sequences), spatial resources (e.g., beams), or the like to be used for the transmission and reception of the downlink reference signal. The configuration of the downlink reference signal may also include one or more of: one or more transmission parameters to be used for the transmission of the downlink reference signal, or a (default) transmission mode that defines (or determines) the one or more transmission parameters mentioned above.

Exemplarily, the configuration of the uplink reference signal may include one or more of: information on time resources (e.g., slots), frequency resources (e.g., frequency blocks), code resources (e.g., code sequences), spatial resources (e.g., beams), or the like to be used for the transmission and reception of the uplink reference signal. The configuration of the uplink reference signal may also be used to configure information about the period of the corresponding reference signal's transmission (i.e., the frequency at which it is transmitted/received).

The network device may also transmit configuration information for the first signal and/or the second signal to specifically configure the first signal and/or the second signal.

To facilitate understanding of the present disclosure, the present disclosure is described hereinafter via Embodiment 1 to Embodiment 4.

### Embodiment 1

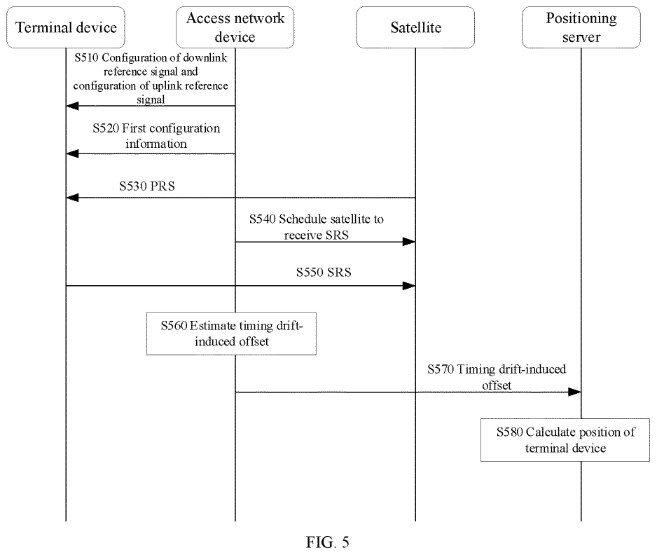

FIG. 5 is a schematic flowchart of a method for wireless communication according to Embodiment 1 of the present disclosure.

The method illustrated in FIG. 5 may be performed by an access network device, a terminal device, a satellite, and a positioning server. In some cases, the access network device and the satellite may be the same device. That is, the access network device may be disposed on the satellite. In some cases, the access network device and the satellite may be different devices. That is, the access network device and the satellite may be separately disposed.

The Embodiment 1 may be a part of a satellite-based multi-RTT positioning method. In the Embodiment 1, a first signal is an SRS, and a second signal is a PRS.

The method illustrated in FIG. 5 may include step S510 to step S580.

In step S510, the access network device or the positioning server transmits a first configuration of a downlink reference signal and a configuration of an uplink reference signal to the terminal device.

In step S520, the access network device estimates an expected time of arrival of the PRS and configures, for the terminal device, a first time window relative to the PRS reception time. The first time window is configured via first configuration information.

The first time window may be accurate to slot-level precision.

The first time window may be represented by an offset and a duration relative to a time of arrival of the PRS, indicating a start time and a duration of the first time window. Alternatively, the access network device may directly indicate two offsets relative to the time of arrival of the PRS, corresponding to the start time and an end time of the first time window respectively. The duration of the first time window shall be configured to ensure that an error between a timing drift estimated based on a center of the first time window and an actual timing drift does not cause a positioning accuracy to exceed a predefined limit. A configuration of the duration of the first time window may be determined based on a requirement for positioning accuracy and a current timing drift rate. The first time window may also be a pre-configured value that provides a sufficiently accurate estimation under any timing drift rate. In this case, the first time window may be determined by configuring only an offset relative to the time of arrival of the PRS.

In step S530, the terminal device receives the PRS from the satellite, and performs a measurement on the PRS based on the configuration of the PRS.

In step S540, the access network device schedules a corresponding serving satellite to receive the SRS, and corresponding SRS configuration information is transmitted to the corresponding satellite.

The configuration information includes information on time resources (e.g., time slots), frequency resources (e.g., frequency blocks), code resources (e.g., code sequences), and/or spatial resources (e.g., beams) for receiving the uplink reference signal, so as to assist the satellite in performing the SRS measurement.

In step S550, the terminal device transmits the SRS based on the received configuration. The satellite or the corresponding access network device receives and measures the SRS.

The terminal device may have received a periodic or an activated semi-persistent SRS configuration. In such a case, in a case where an SRS is to be transmitted within 160 ms of reception of the PRS, the access network device shall configure the start time of the first time window to include at least one SRS therein.

The terminal device may not be scheduled for periodic transmission of the SRS or may not have an activated semi-persistent SRS configuration. In this case, the access network device may configure any suitable first time window and, at the same time, schedule the terminal device to transmit at least one SRS within the first time window.

The Embodiment 1 does not impose a requirement on whether the first time window needs to be located subsequent to the reception of the PRS.

In step S560, the access network device estimates, based on the configured first time window and a cell position of the terminal device, a timing offset generated during a multi-RTT measurement process.

First, the access network device estimates a timing drift rate based on an ephemeris of the satellite and a reference point position within the cell. The reference point position may be specifically a GNSS position of the terminal or a center point position of the cell. Since the timing drift rate varies little within the cell, the reference point position does not need to be overly precise.

Subsequently, the access network device estimates a time duration for which the timing drift needs to be eliminated. The time duration shall be a sum of half of a UE_{Rx-Tx} time difference defined in Option 1 and a time difference delta between the reception of the PRS and the transmission of the SRS. Herein, a time difference between the PRS reception and the SRS transmission may be determined by a center time of the time window configured by the access UE_{Rx-Tx}) network device and the expected time of arrival of the PRS, i.e.,

$$offset = rate \times ( delta + \frac{{UE}_{R x - T x}}{a} ) .$$

In step S570, the access network device estimates a timing offset for the entire process and reports the timing offset to the positioning server. The reporting may be performed by directly reporting the timing offset or by incorporating the timing offset into a report of an Rx-Tx time difference of an access network device. It should be noted that, in multi-satellite multi-RTT positioning, the satellite serves as a reference point for calculating the position of the terminal device. Since a distance between the satellite and the access network device is actually known, whether the measurement is actually performed at the satellite or at the access network device does not affect the implementation of the present disclosure.

In step S580, the positioning server calculates the position of the terminal device based on reports from the terminal device and the access network device.

First, the positioning server determines an RTT based on the reports from the terminal and the access network device.

The RTT is equal to a sum of the UE_{Rx-Tx} time difference, the Rx-Tx time difference of the access network device, and the timing offset. That is: RTT=UE_{Rx-Tx}+gNB_{Rx-Tx}+offset.

Second, the positioning server determines a distance between the terminal device and the satellite based on the RTT, and determines a reference position of the satellite at that time based on the ephemeris reported by the access network device. In a case where distances relative to a plurality of satellite reference positions are acquired via multiple measurements, the position of the terminal device is calculated.

### Embodiment 2

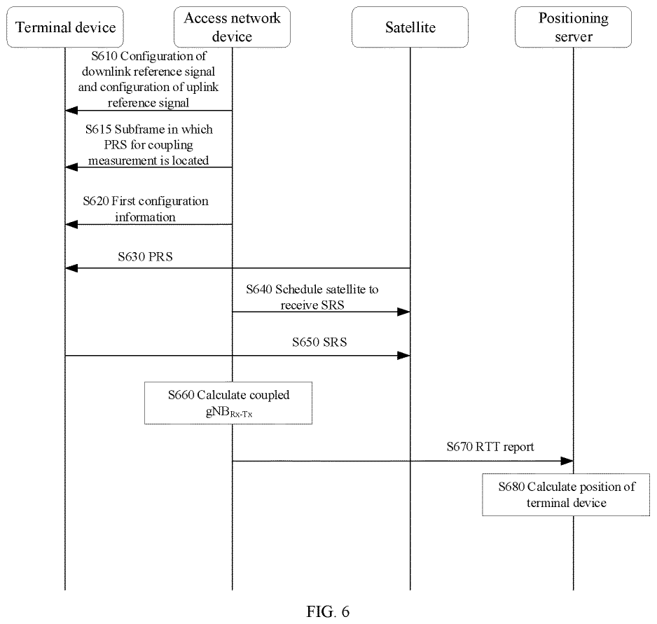

FIG. 6 is a schematic flowchart of a method for wireless communication according to Embodiment 2 of the present disclosure;

The method illustrated in FIG. 6 may be performed by an access network device, a terminal device, a satellite, and a positioning server. In some cases, the access network device and the satellite may be the same device. That is, the access network device may be disposed on the satellite. In some cases, the access network device and the satellite may be different devices. That is, the access network device and the satellite may be separately disposed.

The Embodiment 2 may be a part of a satellite-based multi-RTT positioning method. In the Embodiment 2, a first signal is an SRS, and a second signal is a PRS.

In the Embodiment 2, the first time window implements a coupling relationship between the first signal and the second signal, such that a coupled measurement of a UE_{Rx-Tx} time difference and a gNB_{Rx-Tx} time difference is allowed.

The method illustrated in FIG. 6 may include step S610 to step S680.

In step S610, the access network device or the positioning server transmits a first configuration of a downlink reference signal and a configuration of an uplink reference signal to the terminal device.

In step S615, the access network device selects a PRS for coupled measurement and indicates to the terminal device the subframe in which the PRS is located.

In step S620, the access network device estimates an expected time of arrival of the PRS and configures, for the terminal device, a first time window relative to the PRS reception time. The first time window is configured via first configuration information.

The first time window may be accurate to slot-level precision.

The first time window may be specifically represented by an offset and a duration relative to a time of arrival of the PRS, indicating a start time and a duration of the first time window. Alternatively, the access network device may directly indicate two offsets relative to the time of arrival of the PRS, corresponding to the start time and an end time of the first time window respectively.

In step S630, the terminal device receives the PRS from the satellite, and performs a measurement on the PRS based on the configuration of the PRS. The terminal device transmits an SRS based on the received configuration and records the SRS transmission time. Herein, the terminal device may have received a periodic or an activated semi-persistent SRS configuration. In this case, where an SRS is to be transmitted within 160 ms of reception of the PRS, the access network device should configure the start time of the first time window to include one and only one of these SRSs. The terminal may not be scheduled for periodic SRS transmission or may not have an activated semi-persistent SRS configuration. In this case, the access network device may configure any suitable first time window and, at the same time, schedule the terminal to send one SRS within that first time window. The terminal subtracts the SRS transmission time from the PRS reception time to acquires the coupled UE_{Rx-Tx} time difference.

This window does not necessarily need to be located subsequent to the reception of the PRS. In a case where the first time window is located prior to the reception of the PRS, as long as the terminal is scheduled for an SRS transmission within the first time window, the terminal may still determine which SRS is used for the coupled measurement of the Rx-Tx time difference upon arrival of the PRS, and thus correctly report the UE_{Rx-Tx} time difference.

In step S640, the access network device schedules a corresponding serving satellite to receive and measure the SRS as described above, and corresponding SRS configuration information is transmitted to the corresponding satellite. The configuration information includes information on time resources (e.g., time slots), frequency resources (e.g., frequency blocks), code resources (e.g., code sequences), and/or spatial resources (e.g., beams) for receiving the uplink reference signal, so as to assist the satellite in performing the SRS measurement.

In step S650, the terminal device transmits the SRS.

In step S660, the access network device calculates a coupled gNB_{Rx-Tx} time difference based on a transmission time of the PRS and a time of arrival of the SRS. This time difference may be a difference gNB_{PRS-SRS} between the transmission time of the PRS and the time of arrival of the SRS, or may include a time difference between a time of arrival of an uplink subframe containing the SRS and a transmission time of a nearest downlink subframe (i.e., the gNB_{Rx-Tx} time difference as currently defined) and an integer slot offset indicating the time between the transmission of the PRS and the time of arrival of the SRS.

It should be noted that, in multi-satellite multi-RTT positioning, the satellite serves as a reference point for calculating the position of the terminal device. Since a distance between the satellite and the access network device is actually known, whether the measurement is actually performed at the satellite or at the access network device does not affect the implementation of the Embodiment 2 of the present disclosure.

In step S670, the access network device and the terminal device transmit RTT reports to the positioning server.

In step S680, the positioning server calculates the position of the terminal device.

First, the RTT is determined based on the reports from the terminal and the access network device. The RTT is equal to the difference between the gNB_{Rx-Tx} time difference and the UE_{Rx-Tx} time difference. That is, RTT=gNB_{PRS-SRS}−UE_{Rx-Tx}.

Second, the positioning server determines a distance between the terminal device and the satellite based on the RTT, and determines a reference position of the satellite at that time based on the ephemeris reported by the access network device. In a case where distances relative to a plurality of satellite reference positions are acquired via multiple measurements, the position of the terminal is calculated.

### Embodiment 3

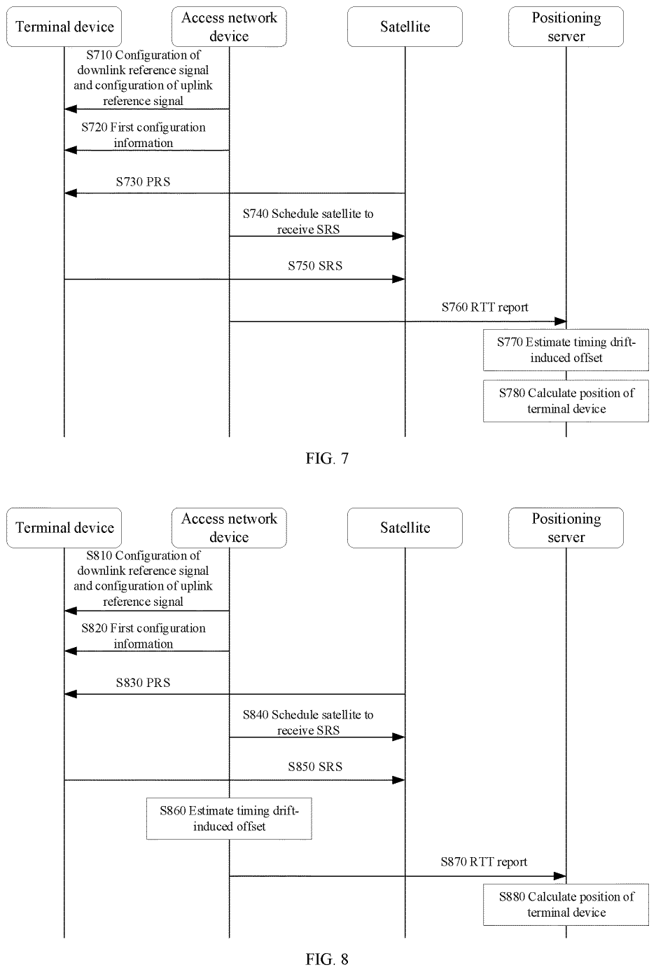

FIG. 7 is a schematic flowchart of a method for wireless communication according to Embodiment 3 of the present disclosure;

The method illustrated in FIG. 7 may be performed by an access network device, a terminal device, a satellite, and a positioning server. In some cases, the access network device and the satellite may be the same device. That is, the access network device may be disposed on the satellite. In some cases, the access network device and the satellite may be different devices. That is, the access network device and the satellite may be separately disposed.

The Embodiment 3 may be a part of a satellite-based multi-RTT positioning method. In the Embodiment 3, a first signal is an SRS, and a second signal is a PRS.

In the Embodiment 3, the first time window enables a correct measurement of a UE_{Rx-Tx} time difference and an Rx-Tx time difference of the access network device.

The method illustrated in FIG. 7 may include step S710 to step S780.

In step S710, the access network device or the positioning server transmits a first configuration of a downlink reference signal and a configuration of an uplink reference signal to the terminal device.

In step S720, the access network device estimates an expected time of arrival of the PRS and configures, for the terminal device, a first time window relative to the PRS reception time. The first time window is configured via first configuration information.

The first time window may be accurate to slot-level precision.

The first time window may be specifically represented by an offset and a duration relative to a time of arrival of the PRS, indicating a start time and a duration of the first time window. Alternatively, the access network device may directly indicate two offsets relative to the time of arrival of the PRS, corresponding to the start time and an end time of the first time window respectively. The duration of the first time window shall be configured to ensure that an error between a timing drift estimated based on a center of the first time window and an actual timing drift does not cause a positioning accuracy to exceed a predefined limit. A configuration of the duration of the first time window may be determined based on a requirement for positioning accuracy and a current timing drift rate. The first time window may also be a pre-configured value that provides a sufficiently accurate estimation under any timing drift rate. In this case, the first time window may be determined by configuring only an offset relative to the time of arrival of the PRS.

In step S730, the terminal device receives the PRS from the satellite, and performs a measurement on the PRS based on the configuration of the PRS.

In step S740, the access network device schedules a corresponding serving satellite to receive the SRS, and corresponding SRS configuration information is transmitted to the corresponding satellite.

The configuration information includes information on time resources (e.g., time slots), frequency resources (e.g., frequency blocks), code resources (e.g., code sequences), and/or spatial resources (e.g., beams) for receiving the uplink reference signal, so as to assist the satellite in performing the SRS measurement.

In step S750, the terminal device transmits the SRS based on the received configuration. The satellite or the corresponding access network device receives and measures the SRS.

The terminal device may have received a periodic or an activated semi-persistent SRS configuration. In such a case, in a case where an SRS is to be transmitted within 160 ms of reception of the PRS, the access network device shall configure the start time of the first time window to include at least one SRS therein.

The terminal may not be scheduled for periodic SRS transmission or may not have an activated semi-persistent SRS configuration. In this case, the access network device may configure any suitable first time window and, at the same time, schedule the terminal device to transmit at least one SRS within the first time window.

The Embodiment 1 do not impose a requirement on whether the first time window needs to be located subsequent to the reception of the PRS.

In addition to reporting the Rx-Tx time difference measurement to the access network device, the access network device also needs to report a configured time window and an ephemeris of the satellite to the positioning server.

In step S760, the access network device and the terminal device transmit RTT reports to the positioning server.

In step S770, the positioning server determines a timing drift-induced offset for the entire process based on the reports from the terminal device and the access network device.

First, the positioning server determines the timing drift-induced offset based on the report from the access network device: the positioning server estimates the timing drift rate based on the ephemeris of the satellite and a selected reference point position within the cell. This reference point position may be specifically a GNSS position of the terminal or a center point position of the cell. Since the timing drift rate varies little within the cell, the reference point position does not need to be overly precise. The positioning server then determines a time period for which timing drift needs to be eliminated based on the report from the access network device. The time duration shall be a sum of half of a UE_{Rx-Tx} time difference newly defined and a time difference between the reception of the PRS and the transmission of the SRS. Herein, a time difference between the PRS reception and the SRS transmission may be determined by a center time of the time window configured by the access network device and the expected time of arrival of the PRS, i.e.,

$$offset = rate \times ( delta + \frac{{UE}_{Rx - Tx}}{a} ) .$$

In step S780, the positioning server determines the position of the terminal device by combining the reports from the terminal and the access network device.

First, the positioning server determines the RTT. The RTT is equal to a sum of the UE_{Rx-Tx} time difference, the gNB_{Rx-Tx} time difference, and the timing drift-induced offset. That is:

$$RTT = {UE}_{Rx - Tx} + {ℊNB}_{Rx - Tx} + offset .$$

Second, the positioning server determines a distance from the terminal to the satellite based on the RTT, and determines a reference position of the satellite at this time based on the ephemeris reported by the access network device. In a case where distances relative to a plurality of satellite reference positions are acquired via multiple measurements, the position of the terminal device is calculated.

### Embodiment 4

The Embodiment 4 is directed to the scenario illustrated in FIG. 3C.

FIG. 8 is a schematic flowchart of a method for wireless communication according to Embodiment 4 of the present disclosure;

The method illustrated in FIG. 8 may be performed by an access network device, a terminal device, a satellite, and a positioning server. In some cases, the access network device and the satellite may be the same device. That is, the access network device may be disposed on the satellite. In some cases, the access network device and the satellite may be different devices. That is, the access network device and the satellite may be separately disposed.

The Embodiment 4 may be a part of a satellite-based multi-RTT positioning method. In the Embodiment 4, a first signal is an SRS, and a second signal is a PRS.

The method illustrated in FIG. 8 may include step S810 to step S880.

In the Embodiment 4, the first time window allows the terminal device to achieve correct measurement of a multi-satellite UE_{Rx-Tx} time difference and a gNB_{Rx-Tx} time difference with as little uplink SRS overhead as possible.

In step S810, the access network device or the positioning server transmits a first configuration of a downlink reference signal and a configuration of an uplink reference signal to the terminal device.

The configurations of the downlink reference signal and the uplink reference signal may define radio resources for the downlink reference signal and the uplink reference signal. Exemplarily, the configuration of the downlink reference signal may include, for example: information on time resources (e.g., slots), frequency resources (e.g., frequency blocks), code resources (e.g., code sequences), and/or spatial resources (e.g., beams) to be used for transmission and reception of the downlink reference signal. Generally, for example, the configuration of the downlink reference signal may also include: one or more transmission parameters to be used for the transmission of the downlink reference signal, or a (default) transmission mode that defines (or determines) the one or more transmission parameters mentioned above. Correspondingly, for example, the configuration of the downlink reference signal may include: information on time resources (e.g., slots), frequency resources (e.g., frequency blocks), code resources (e.g., code sequences), and/or spatial resources (e.g., beams) to be used for transmission and reception of the uplink reference signal. The configuration of the uplink reference signal may also be used to configure information about the period of transmission of the corresponding reference signal (i.e., the frequency at which it is transmitted/received). The downlink reference signal may be specifically a PRS, and the uplink reference signal may be specifically an SRS. The configured PRS is from a serving satellite and is scheduled by the access network device or the positioning server. The configurations for the PRS and SRS may have been previously received from the access network device. The access network device may have already received the aforementioned configurations from the positioning server. In this embodiment, the access network device schedules the terminal to receive PRSs from the serving satellite and from one or more non-serving satellites. The access network device configures a measurement gap or a PRS processing window (PPW) for the terminal to allow the terminal to receive PRSs from the non-serving satellites.

In step S820, the access network device configures a first time window for the terminal device. The first time window is configured via first configuration information.

The first time window may be accurate to slot-level precision.

The first time window may be specifically represented by an offset and a duration relative to a time of arrival of the PRS, indicating a start time and a duration of the first time window. Alternatively, the access network device may directly indicate two offsets relative to the time of arrival of the PRS, corresponding to the start time and an end time of the first time window respectively. This window may be flexibly configured. For example, in a case where there is an intersection within a specific interval of PRS arrivals (e.g., 160 ms), the window may be configured in this interval, such that a plurality of satellites are allowed to use the same one or more SRSs transmitted by the UE for measurement.

In one situation, a difference between expected time of arrivals of all PRSs does not exceed 320 ms. For example, the expected time of arrival of a PRS transmitted by Sat A is around 0 ms; the expected time of arrival of a PRS transmitted by Sat B is around 150 ms; and the expected time of arrival of a PRS transmitted by Sat C is around 300 ms. Herein, Sat A is the serving satellite. Then, the access network device may configure a first time window for the terminal device in an interval (140 ms, 160 ms).

In one situation, the difference in the expected time of arrivals between two or more groups of PRSs from non-serving satellites does not exceed 320 ms, but the expected time of arrival of another group of PRSs differs from the expected time of arrivals of all other PRSs by more than 320 ms. For example, the expected time of arrival of the PRS transmitted by Sat A is 0 ms; the expected time of arrival of the PRS transmitted by Sat B is 330 ms; and the expected time of arrival of the PRS transmitted by Sat C is 500 ms. The access network device may configure, for the terminal device, one first time window in an interval (−160 ms, 160 ms) and another first time window in an interval (340 ms, 490 ms).

In one case, the difference in the expected time of arrivals between two or more groups of PRSs does not exceed 320 ms, and the expected time of arrival of another group of PRSs differs from one or more groups of PRSs by no more than 320 ms, but differs from the time of arrivals of other PRSs by more than 320 ms. For example, the expected time of arrival of the PRS transmitted by Sat A is 0 ms; the expected time of arrival of the PRS transmitted by Sat B is 300 ms; and the expected time of arrival of the PRS transmitted by Sat C is 500 ms. Based on the implementation, the access network device may configure one first time window in an interval (140 ms, 160 ms) and another first time window in an interval (340 ms, 460 ms), respectively. In this situation, the access network device may select, according to its own situation, select SRS in any one of the time windows for measurement to complete the RTT measurement relative to Sat B.

In step S830, the terminal device receives the PRS from the satellite, and performs a measurement on the PRS based on the configuration of the PRS.

In step S840, the access network device schedules a corresponding serving satellite to receive the one or more SRSs as described above, and corresponding SRS configuration information is transmitted to the corresponding satellite. The configuration information includes information on time resources (e.g., time slots), frequency resources (e.g., frequency blocks), code resources (e.g., code sequences), and/or spatial resources (e.g., beams) for receiving the uplink reference signal, so as to assist the satellite in performing the SRS measurement.

In step S850, the terminal device transmits the SRS based on the received configuration. The satellite or the corresponding access network device receives and measures the SRS.

The terminal device may have received a periodic or an activated semi-persistent SRS configuration. In this case, in a case where a periodic or an activated semi-persistent SRS that needs to be transmitted is included within the time window configurable by the access network device, the access network device should configure the start time of the first time window to include at least one of these SRSs.

The terminal may not be scheduled for periodic SRS transmission or may not have an activated semi-persistent SRS configuration. In this case, the access network device may configure any suitable first time window and, at the same time, schedule the terminal device to transmit at least one SRS within the first time window.

In step S860, the access network device estimates, based on the configured first time window and the cell position where the terminal is located, timing drift-induced offsets generated by a plurality of satellites during the multi-RTT measurement process. First, the access network device estimates the timing drift rate brought by each satellite based on an ephemeris of the satellite and a reference point position within the cell. This reference point position may be specifically a GNSS position of the terminal or a center point position of the cell. Since the timing drift rate varies little within the cell, the reference point position does not need to be overly precise. Subsequently, the access network device estimates a time duration for which the timing drift needs to be eliminated. The time duration shall be a sum of half of a UE_{Rx-Tx} time difference newly defined and a time difference delta between the reception of the PRS and the transmission of the SRS. Herein, a time difference between the PRS reception and the SRS transmission may be determined by a center time of the time window configured by the access network device and the expected time of arrival of the PRS, i.e.,

$$offset = rate \times ( delta + \frac{{UE}_{Rx - Tx}}{a} ) .$$

The access network device estimates a timing drift-induced offset for the entire process, and reports the timing drift-induced offset to the positioning server. The reporting may refer to direct reporting or incorporating the timing drift-induced offset into the gNB_{Rx-Tx} time difference report (i.e., the RTT report). It should be noted that, in multi-satellite multi-RTT positioning, the satellite serves as a reference point for calculating the position of the terminal device. Since a distance between the satellite and the access network device is actually known, whether the measurement is actually performed at the satellite or at the access network device does not affect the implementation of the Embodiment 2 of the present disclosure.

In step S870, the access network device and the terminal device transmit RTT reports to the positioning server.

In step S880, the positioning server calculates the position of the terminal device based on reports from the terminal device and the access network device.

First, the positioning server determines an RTT between the terminal and the serving satellite based on the reports from the terminal and the access network device, and thereby determines a distance from the terminal to the serving satellite. RTTs=UE_{Rx-Tx}+gNB_{Rx-Tx}+offset. That is, RTTs=UE_{Rx-Tx}+gNB_{Rx-Tx}+offset_{∘}.

The positioning server then determines a distance between a non-serving satellite and the terminal. A specific calculation method is to determine the RTT between the non-serving satellite and the terminal device, RTT_{B2}, based on the reports from the terminal and the access network device, thereby acquiring a sum of the distance from the non-serving satellite to the terminal and the distance from the terminal to the serving satellite, and then performing subtraction.

The positioning server determines the reference positions of all satellites at the time of measurement based on the ephemeris reported by the access network device. In this way, the terminal position is determined.

The method embodiments of the present disclosure have been described in detail above. Hereinafter, apparatus embodiments of the present disclosure are described in detail. It should be understood that the descriptions of the method embodiments and the apparatus embodiments correspond to each other; therefore, for parts not described in detail, reference may be made to the preceding method embodiments.

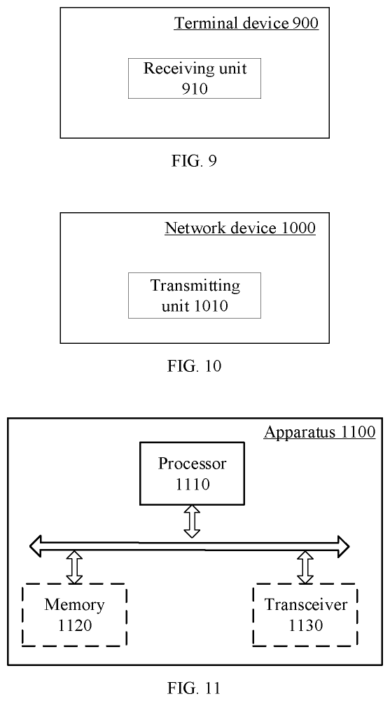

FIG. 9 is a schematic structural diagram of a terminal device according to some embodiments of the present disclosure. The terminal device 900 may include a receiving unit 910.

The receiving unit 910 is configured to receive first configuration information from a network device; wherein he first configuration information is used to configure a first time window, and the terminal device is to transmit a first signal within the first time window, wherein the first signal is used to determine an RTT between the terminal device and the network device, the RTT being implemented based on a second signal received by the terminal device.

In some embodiments, the first configuration information is used to indicate one or more of: a start time of the first time window; an end time of the first time window; or a duration of the first time window.

In some embodiments, the start time is indicated by a first offset, and the start time is a sum of the first offset and a first time, wherein the first time is a time when the terminal device receives the second signal.

In some embodiments, the duration of the first time window is pre-configured and/or pre-defined.

In some embodiments, the first signal is a first-type signal, and the first time window is determined based on scheduling information of the first-type signal.

In some embodiments, the first time window includes one or more transmission times of the first-type signal scheduled based on the scheduling information.

In some embodiments, in a case where a duration between the transmission time of the first-type signal and a first time is less than a first threshold, the first time window includes the transmission time of the first-type signal, wherein the first time is a time when the terminal device receives the second signal.

In some embodiments, the first threshold may be 160 ms.

In some embodiments, the first time window is used to determine a timing drift-induced offset.

In some embodiments, the first time window is used to estimate a first time difference between a reception time of the second signal and a transmission time of the first signal, wherein the first time difference is used to determine the timing drift-induced offset.

In some embodiments, the first time difference is determined by a center time of the first time window and an expected time of arrival of the second signal.

In some embodiments, the timing drift-induced offset satisfies:

$$offset = rate \times ( delta + \frac{{UE}_{Rx - Tx}}{a} ) ,$$

wherein rate represents a timing drift rate, delta represents the first time difference, UE_{Rx-Tx} represents a time difference between receiving the second signal and transmitting the first signal at the terminal device, and a is a positive number.

In some embodiments, the timing drift-induced offset is used to determine the RTT.

In some embodiments, the RTT satisfies: RTT=UE_{Rx-Tx}+gNB_{Rx-Tx}+offset; wherein UE_{Rx-Tx} represents a time difference between receiving the second signal and transmitting the first signal at the terminal device, and gNB_{Rx-Tx} represents a time difference between receiving the first signal and transmitting the second signal at the network device.

In some embodiments, in a case where the terminal device receives a plurality of second signals, the first configuration information is used to configure one or more of the first time windows.

In some embodiments, in a case where a reception time difference of the plurality of second signals is less than or equal to a second threshold, the network device configures one first time window.

In some embodiments, the second threshold may be 320 ms.

In some embodiments, the first configuration information is further used to indicate that the first signal and the second signal are coupled.

In some embodiments, a receiver of the first signal includes a non-terrestrial communication device.

In some embodiments, the receive unit 910 may be a transceiver 1130. The terminal device 900 may further include a processor 1110 and a memory 1120, as specifically illustrated in FIG. 11.

FIG. 10 is a schematic structural diagram of a network device 1000 according to some embodiments of the present disclosure. The network device 1000 includes a transmitting unit 1010.

The transmitting unit 1010 is configured to transmit first configuration information to a terminal device; wherein he first configuration information is used to configure a first time window, and the terminal device is to transmit a first signal within the first time window, wherein the first signal is used to determine an RTT between the terminal device and the network device, the RTT being implemented based on a second signal received by the terminal device.

In some embodiments, the first configuration information is used to indicate one or more of: a start time of the first time window; an end time of the first time window; or a duration of the first time window.

In some embodiments, the start time is indicated by a first offset, and the start time is a sum of the first offset and a first time, wherein the first time is a time when the terminal device receives the second signal.

In some embodiments, the duration of the first time window is pre-configured and/or pre-defined.

In some embodiments, the first signal is a first-type signal, and the first time window is determined based on scheduling information of the first-type signal.

In some embodiments, the first time window includes one or more transmission times of the first-type signal scheduled based on the scheduling information.

In some embodiments, in a case where a duration between the transmission time of the first-type signal and a first time is less than a first threshold, the first time window includes the transmission time of the first-type signal, wherein the first time is a time when the terminal device receives the second signal.

In some embodiments, the first threshold may be 160 ms.

In some embodiments, the first time window is used to determine a timing drift-induced offset.

In some embodiments, the first time window is used to estimate a first time difference between a reception time of the second signal and a transmission time of the first signal, wherein the first time difference is used to determine the timing drift-induced offset.

In some embodiments, the first time difference is determined by a center time of the first time window and an expected time of arrival of the second signal.

In some embodiments, the timing drift-induced offset satisfies:

$$offset = rate \times ( delta + \frac{{UE}_{Rx - Tx}}{a} ) ,$$

wherein rate represents a timing drift rate, delta represents the first time difference, UE_{Rx-Tx} represents a time difference between receiving the second signal and transmitting the first signal at the terminal device, and a is a positive number.

In some embodiments, the timing drift-induced offset is used to determine the RTT.

In some embodiments, the RTT satisfies: RTT=UE_{Rx-Tx}+gNB_{Rx-Tx}+off set; wherein UE_{Rx-Tx} represents a time difference between receiving the second signal and transmitting the first signal at the terminal device, and gNB_{Rx-Tx} represents a time difference between receiving the first signal and transmitting the second signal at the network device.

In some embodiments, in a case where the terminal device receives a plurality of second signals, the first configuration information is used to configure one or more of the first time windows.

In some embodiments, in a case where a reception time difference of the plurality of second signals is less than or equal to a second threshold, the network device configures one first time window.

In some embodiments, the second threshold may be 320 ms.

In some embodiments, the first configuration information is further used to indicate that the first signal and the second signal are coupled.

In some embodiments, a receiver of the first signal includes a non-terrestrial communication device.

In some embodiments, the transmitting unit 1010 may be a transceiver 1130. The network device 1000 may further include a processor 1110 and a memory 1120, as specifically illustrated in FIG. 11.

FIG. 11 is a schematic diagram of an apparatus 1100 for communication according to some embodiments of the present disclosure. The dotted lines in FIG. 11 indicate that the unit or module is optional. The apparatus 1100 may be employed to perform the method according to the above method embodiments. The apparatus 1100 may be a chip, a terminal device, or a network device.

The apparatus 1100 may include one or more processors 1110. The processor 1110 may support implementation of the methods according to the above method embodiments by the apparatus 1100. The processor 1110 may be a general purpose processor or an application-specific processor. For example, the processor may be a central processing unit (CPU). The processor may be a general processor, a digital signal processor (DSP), an application-specific integrated circuit (ASIC), a field-programmable gate array (FPGA) or another programmable logic device, a discrete gate or transistor logic device, or a discrete hardware component, or the like. The general-purpose processor may be a microprocessor or any customary processor or the like.

The apparatus 1100 may further include one or more memories 1120. The memory 1120 has stored thereon a program that is executable by the processor 1110 to cause the processor 1110 to perform the method described in the above method embodiments. The memory 1120 may be separate from the processor 1110 or integrated within the processor 1110.

The apparatus 1100 may also include a transceiver 1130. The processor 1110 may communicate with other devices or chips by the transceiver 1130. For example, the processor 1110 may communicate (transmit and receive) data with other devices or chips by the transceiver 1130.

Some embodiments of the present disclosure further provide a computer-readable storage medium configured to store one or more programs. The computer-readable storage medium may be applied to a terminal device or a network device according to the embodiments of the present disclosure, and the one or more programs cause a computer to perform the method performed by the terminal device or the network device according to the respective embodiments of the present disclosure.

Some embodiments of the present disclosure further provide a computer program product. The computer program product includes one or more programs. The computer program product may be applied to a terminal device or a network device according to the embodiments of the present disclosure, and the one or more programs cause a computer to perform the method performed by the terminal device or the network device according to the respective embodiments of the present disclosure.

Some embodiments of the present disclosure further provide a computer program. The computer program may be applied to a terminal device or a network device according to the embodiments of the present disclosure, and the program causes a computer to perform the method performed by the terminal device or the network device according to the respective embodiments of the present disclosure.

It should be understood that the terms “system” and “network” in the specification are generally exchanged. Further, the terms used herein are for the purpose of describing particular embodiments only and are not intended to limit the present disclosure. The terms such as “first,” “second,” “third,” “fourth,” and the like in the specifications, claims and the accompanying drawings of the present disclosure are intended to distinguishing different objects but are not intended to define a specific sequence. In addition, terms “comprise,” “include,” and variations thereof are intended to define a non-exclusive meaning.

In the embodiments of the present disclosure, the term “indication” mentioned in the specification may indicate a direct indication, an indirect indication, or an association. By way of example, the expression “A indicates B” may mean that A directly indicates B, e.g., B may be obtained by A; or mean that A indicates B indirectly, for example A indicates C, and B may be obtained by C; or mean that an association is present between A and B.

In the embodiments of the present disclosure, the expression “B corresponding to A” means that B is associated with A, from which B may be determined. However, it should also be understood that determining B from A does not mean determining B from A alone, and B may also be determined from A and/or other information.

In the embodiments of the present disclosure, the term “correspond” or derivatives thereof may mean that there is a direct correspondence or an indirect correspondence between the two, that a correlation is present between the two, and that there is a relationship between indicating and being indicated, configuring and being configured, or the like.

In embodiments of the present disclosure, “pre-defined” or “pre-configured” may be implemented by pre-storing a corresponding code, table, or other means that may be used to indicate relevant information in a device (e.g., including a terminal device and a network device), and the present disclosure does not limit the specific implementation thereof. For example, the term “predefined” may refer to “defined in the protocol.”

In embodiments of the present disclosure, the term “protocol” may refer to a standard protocol in the field of communications, and may include, for example, the LTE protocol, the NR protocol, and related protocols used in future communication systems, without limitation.

In the description of the embodiments of the present disclosure, the term “and/or” is merely an association relationship for describing associated objects, which represents that there may exist three types of relationships. For example, the phrase “A and/or B” may indicate (A), (B), or (A and B). In addition, the forward-slash symbol “/” generally represents an “or” relationship between associated objects before and after the symbol.

In the embodiments of the present disclosure, the term “comprise” or derivatives thereof may refer to direct inclusion or indirect inclusion. Optionally, the term “comprise” or derivatives thereof as used in the embodiments of the present disclosure may be replaced with “indicate” or “used to determine, or for determining.” For example, “A comprises B” may be replaced with “A indicates B” or “A is used to determine B.”

It should be understood that in various embodiments of the present disclosure, the sequence numbers of the above various processes or steps do not denote a preferred sequence of performing the processes or steps; and the sequence of performing the processes and steps should be determined according to the functions and internal logics thereof, which shall not cause any limitation to the implementation process of the embodiments of the present disclosure.

In the several embodiments provided in the present disclosure, it should be understood that the disclosed system, apparatus and method may be practiced in other manners. The above described device embodiments are merely illustrative. For example, the unit division is merely logical function division and may be other divisions in actual practice. For example, a plurality of units or components may be combined or integrated into another device, or some features may be ignored or not performed. Additionally, the displayed or discussed mutual couplings or direct couplings or communication connections may be implemented through some interfaces. The indirect couplings or communication connections between the devices or units may be implemented in electronic, mechanical or other forms.

The units which are described as separate components may be physically separated or may be not physically separated, and the components which are illustrated as units may be or may not be physical units, that is, the components may be located in the same position or may be distributed into a plurality of network units. Some of or all of the units may be selected according to actual needs to achieve the objectives of the solutions of the embodiments.

In addition, functional units in the embodiments of the present disclosure may be integrated into one processing unit, or each of the units may exist along physically, or two or more units may be integrated into one unit.

In the above embodiments, the technical solutions may be totally or partially practiced by software, hardware, firmware or any combination thereof. During practice by software, the technical solutions may be totally or partially implemented in the form of a computer program product. The computer program product includes one or a plurality of computer-executable instructions. The computer program instructions, when loaded and executed on a computer, may cause the computer to totally or partially perform the procedures or functions in the embodiments of the present disclosure. The computer may be a general computer, a dedicated computer, a computer network, or another programming device. The computer-executable instructions may be stored in a computer-readable storage medium, or transferred from one computer-readable storage medium to another. For example, the computer-executable instructions may be transmitted from one website, computer, server or data center to another in a wired fashion, for example, a coaxial cable, an optical fiber, a digital subscriber line (DSL) or a wireless fashion, for example, an infrared ray, a radio, a microwave or the like. The computer-readable storage medium may be any available medium that is accessible or a data storage device such as a server, a data center or the like integrated with one or a plurality of available media. The available medium may be a magnetic medium, for example, a floppy disk, a hard disk or a magnetic tape, an optical medium, for example, a digital versatile disc (DVD), or a semiconductor medium, for example, a solid state disk (SSD) or the like.

The above embodiments are used only for illustrating the present disclosure, but are not intended to limit the protection scope of the present disclosure. Various modifications and replacements readily derived by those skilled in the art within technical disclosure of the present disclosure shall fall within the protection scope of the present disclosure. Therefore, the protection scope of the present disclosure is subject to the appended claims.

What is claimed is:

1. A terminal device, comprising: a memory and a processor; wherein the memory is configured to store one or more programs, and the processor is configured to call the one or more programs stored in the memory to cause the terminal device to execute following operation:
receiving first configuration information from a network device;
wherein the first configuration information indicates a first time window, and the terminal device is configured to transmit a first signal within the first time window, the first signal is used to determine a round trip rime (RTT) between the terminal device and the network device, and the RTT is implemented based on a second signal received by the terminal device.

2. The terminal device according to claim 1, wherein the first configuration information indicates one or more of:
a start time of the first time window;
an end time of the first time window; or
a duration of the first time window.

3. The terminal device according to claim 2, wherein the start time indicates by a first offset, the start time is a sum of the first offset and a first time, and the first time is a time when the terminal device receives the second signal.

4. The terminal device according to claim 1, wherein a duration of the first time window is pre-configured and/or pre-defined.

5. The terminal device according to claim 1, wherein the first signal is a first-type signal, and the first time window is determined based on scheduling information of the first-type signal.

6. The terminal device according to claim 5, wherein the first time window comprises one or more transmission times of the first-type signal scheduled based on the scheduling information.

7. The terminal device according to claim 6, wherein in a case where a duration between the transmission time of the first-type signal and a first time is less than a first threshold, the first time window comprises the transmission time of the first-type signal, and the first time is a time when the terminal device receives the second signal.

8. The terminal device according to claim 1, wherein the first time window corresponds to a timing drift-induced offset of the RTT.

9. The terminal device according to claim 8, wherein the first time window is used to estimate a first time difference between a reception time of the second signal and a transmission time of the first signal, and the first time difference is used to determine the timing drift-induced offset.

10. The terminal device according to claim 9, wherein the first time difference is determined by a center time of the first time window and an expected time of arrival of the second signal.

11. The terminal device according to claim 10, wherein the timing drift-induced offset satisfies:
$$offset = rate \times ( delta + \frac{{UE}_{Rx - Tx}}{a} ) ,$$
wherein rate represents a timing drift rate, delta represents the first time difference, UE_{Rx-Tx} represents a time difference between receiving the second signal and transmitting the first signal at the terminal device, and a is a positive number.

12. The terminal device according to claim 8, wherein the timing drift-induced offset is used to determine the RTT.

13. The terminal device according to claim 12, wherein the RTT satisfies: RTT=UE_{Rx-Tx}+gNB_{Rx-Tx}+offset; wherein UE_{Rx-Tx} represents a time difference between receiving the second signal and transmitting the first signal at the terminal device, and gNB_{Rx-Tx} represents a time difference between receiving the first signal and transmitting the second signal at the network device.

14. The terminal device according to claim 1, wherein in a case where the terminal device receives a plurality of second signals, the first configuration information is used to configure one or more of the first time windows.

15. The terminal device according to claim 14, wherein in a case where a reception time difference of the plurality of second signals is less than or equal to a second threshold, the network device configures one first time window.

16. The terminal device according to claim 1, wherein the first configuration information is further used to indicate that the first signal and the second signal are coupled.

17. The terminal device according to claim 1, wherein a receiver of the first signal comprises a non-terrestrial communication device.

18. A network device, comprising: a memory and a processor; wherein the memory is configured to store one or more programs, and the processor is configured to call the one or more programs stored in the memory to cause the network device to execute following operation:
transmitting first configuration information to a terminal device;
wherein the first configuration information is used to configure a first time window, and the terminal device is configured to transmit a first signal within the first time window, the first signal is used to determine a round trip rime (RTT) between the terminal device and the network device, and the RTT is implemented based on a second signal received by the terminal device.

19. The network device according to claim 18, wherein the first configuration information is used to indicate one or more of:
a start time of the first time window;
an end time of the first time window; or
a duration of the first time window.

20. A method for wireless communication, comprising:
receiving, by a terminal device, first configuration information from a network device;
wherein the first configuration information indicates a first time window, and the terminal device is configured to transmit a first signal within the first time window, the first signal is used to determine a round trip rime (RTT) between the terminal device and the network device, and the RTT is implemented based on a second signal received by the terminal device.
